(19) United States
(12) Patent Application Publication
(10) Pub. No.: US 2024/0157894 A1
(43) Pub. Date: May 16, 2024

(54) METHOD FOR OPERATING A MOTOR VEHICLE DOOR

(71) Applicant: KIEKERT AKTIENGESELLSCHAFT, Heiligenhaus (DE)

(72) Inventors: Ingo NÖVERMANN, Mülheim an der Ruhr (DE); Nils Sören GUNTRUM, Meckenheim (DE); Christian WOLF, Köln (DE)

(73) Assignee: KIEKERT AKTIENGESELLSCHAFT, Heiligenhaus (DE)

(21) Appl. No.: 18/549,683

(22) PCT Filed: Mar. 9, 2022
(86) PCT No.: PCT/DE2022/100188

§ 371 Date: Sep. 8, 2023

(30) Foreign Application Priority Data
Mar. 22, 2021 (DE) 10 2021 106 976.9

(51) Int. Cl. B60R 16/027; B60R 16/03; E05B 81/56; E05F 15/60

(52) U.S. Cl. CPC B60R 16/027; B60R 16/03; E05B 81/56; E05F 15/60; E05Y 2400/40; E05Y 2400/44; E05Y 2400/61; E05Y 2400/654; E05Y 2400/66; E05Y 2900/531

(57) ABSTRACT

A method for operating a motor vehicle door, according to which method the motor vehicle door is equipped, for example, with an actuator and/or a motor vehicle door lock in the form of a current consumer, and at least one sensor for detecting door movements. In addition, a control unit that evaluates signals from the sensor is provided which can be transferred from a rest mode into an operating mode and back again according to the recorded door movements. According to the invention, the door movement causes the sensor that is deenergised in the rest mode to generate a current pulse.

The invention relates to a method for operating a motor vehicle door, according to which the motor vehicle door is equipped, for example, with an actuator and/or a motor vehicle door lock as a current consumer, and at least one sensor for detecting door movements, and according to which a control unit evaluating signals from the sensor is transferred from a rest mode into an operating mode and back, depending on registered door movements.

In this case, the control unit is at least able to evaluate the signals of the sensor. As a rule, the control unit additionally serves to monitor and optionally control the actuator and/or the motor vehicle door lock. The term motor vehicle door is to be interpreted broadly in the present case and comprises all flaps, covers, doors etc. that are movable relative to a vehicle body, both in the interior and on the outside.

Such a method is described in the context of DE 10 2006 058 723 A1. In fact, here it relates to implementing keyless access to a vehicle door. In this case, overall a proximity sensor is used, by means of which a door control device can be transferred from a first operating mode into a second operating mode. The two operating modes are, on the one hand, a rest mode and, on the other hand, an operating mode.

In addition to such proximity sensors as in the previously described prior art according to DE 10 2006 058 723 A1, acceleration sensors are also known in principle in this context. DE 10 2006 030 986 B4 is cited as an example of this. Here, a device and a method for controlling a vehicle flap are described. The acceleration of the vehicle flap or vehicle door can be detected by means of the acceleration sensor.

DE 10 2007 062 472 B4 takes a similar approach. This relates to a device for adjusting an actuating force of an actuator to support an opening and/or closing movement. The adjustment of the actuating force of the actuator to the respective operating situation of the door now takes place with the aid of an evaluation device. For this purpose, inter alia, an acceleration sensor arranged in the vicinity of the door handle is provided.

The prior art has proven itself in principle, if it is a question of transferring a control unit from a rest mode into an operating mode and back, by means of a sensor in or on the associated motor vehicle door. However, the correct functioning requires that the sensor itself and also the control unit are in principle energized. In view of the numerous electrical consumers or current consumers in a motor vehicle, there is a general need to reduce, in particular, the idle current or the power consumption in the rest mode. At this point, improvements are still possible.

The invention is based on the technical problem of further developing such a method for operating a motor vehicle door, in such a way that the current consumption is reduced again, in particular in the rest mode, compared to previous approaches.

In order to solve this technical problem, the invention proposes, in a generic method for operating a motor vehicle door, that the sensor, which is deenergized in the rest mode, should generate a current pulse by the door movement.

In principle, the procedure is such that the control unit is woken up with the aid of the aforementioned current pulse, and transitions from the rest mode into the operating mode. In the rest mode, the control unit is further and generally also deenergized. That is to say that the rest mode is characterized, in the context of the invention, in that both the sensor and the control unit evaluating the sensor are each deenergized, that is to say do not consume a quiescent current. The same applies to the current consumer.

The sensor itself generates a current pulse only when a door movement takes place. This current pulse of the sensor is used to wake up the control unit or to transfer it from its deenergized rest mode into the operating mode.

For this purpose, the invention regularly assumes that the current pulse generated by the sensor by the door movement activates a power supply unit assigned to the control unit. The power supply unit is therefore switched on in the first place by means of the current pulse generated by the sensor, or is transferred from its state which is assumed in the rest mode and also deenergized, into the active state. As soon as the power supply unit is activated, the control unit is energized with the aid of said power supply unit, and can then transition from the previously assumed deenergized rest mode into the operating mode. That is to say that the activated power supply unit transfers the control unit from the rest mode into the operating mode.

In this way, the idle current required according to the invention is significantly reduced again compared to previous approach. In the rest mode, both the control unit and the sensor and the power supply unit supplying the control unit with electrical energy are each deenergized. This is the same for the current consumer(s). Only when a door movement takes place does this ensure, via the sensor, that the current pulse is generated. The current pulse produced by the sensor activates the power supply unit, which in turn supplies the control unit with the required electrical energy so that this can be transferred from its rest mode into the operating mode. Such energy management, observed in this sequence, has not been considered possible until now.

In this case, the sensor assumes a core function such that, using said sensor, it is not only possible to detect the movements of the motor vehicle door in the operating state, but rather the sensor generally also ensures that, proceeding from the rest mode of the current pulse generated by its movement, the power supply unit is activated, which then in turn transfers the control unit into the operating mode. The same also applies to the sensor. Herein lie the essential advantages.

According to an advantageous embodiment, the sensor is an inductively operating acceleration sensor or a sensor of the type that, during its movement, generates electrical current induced by the movement. This can be realized and implemented, in detail and advantageously, in such a way that, in the simplest case, the sensor is equipped with one or more coils and one or more permanent magnets movable in relation thereto. In this case, the permanent magnets are advantageously arranged and aligned in such a way that, during a movement of the motor vehicle door in question, it performs a movement relative to the coil or coils which are stationary in relation thereto, and current is thereby induced in the coils. The current induced in this way now ensures the current pulse, which is used according to the invention to activate the power supply unit, which then in turn transfers the control unit from the rest mode to the operating mode. In principle, however, the sensor can also be equipped with a correspondingly operating induction unit.

For this purpose, the induction unit described above and assigned to the sensor can operate in the linear direction, for example. That is to say that, in this case, the for example rod-shaped permanent magnet moves linearly relative to the one or more stationary coils. In principle, however, it is also possible for the induction unit to operate rotationally. In this case, one or more coils can be arranged in a circular manner. As soon as this circular arrangement rotates relative to a stationary permanent magnet, this again leads to an induction of electrical current in the coils, which can be used for the current pulse already mentioned above.

According to the invention, the linear or rotationally operating induction unit can now not only be used as a wakeup pulse for generating the current pulse.

Rather, in principle, the linearly or rotationally operating induction unit can also be used originally as a sensor. This is because the acceleration of the permanent magnet moved linearly with respect to the coils, and the induced current signal associated therewith, represent a measure both of the acceleration and of the rotational speed in the case of the rotationally operating induction unit. That is to say that, in this case, the sensor itself is designed as an inductively operating acceleration sensor. In principle, however, the induction unit can also be combined with a further sensor, which is designed for example on a semiconductor basis or as a Hall sensor. That is to say that the sensor can generally be designed as an inductively operating acceleration sensor and/or include an induction unit.

As a rule, the sensor is coupled to the power supply unit via a communication link. The communication link can in principle operate wirelessly or by wire. In this case, the design is usually such that only the communication link is active in the rest mode. In contrast, the sensor, the power supply unit, the control unit, and generally also all the current consumers controlled by the control unit, are deenergized. These include, by way of example, the previously mentioned actuator and/or the motor vehicle door lock. In this way, for example, an actuator which moves the motor vehicle door or supports the movement is deenergized in the rest mode. This also and in particular applies in the event that the motor vehicle door is open and is at rest. Only when the control unit is transferred from the rest mode into the operating mode by means of the current pulse generated by the sensor does the control unit ensure overall, in conjunction with the activated power supply unit, that the actuator can then assist the movement of the motor vehicle door as desired. Of course, this only applies as an example.

As a rule, the control unit and the sensor are arranged in a door leaf of the motor vehicle door. In contrast, the power supply unit is usually located on the body side. As a result, a significantly reduced electrical power consumption compared to previous embodiments is observed, in particular in the rest mode. Herein lie the essential advantages.

The invention is explained in greater detail below with reference to a drawing which shows only one exemplary embodiment. In the drawing:

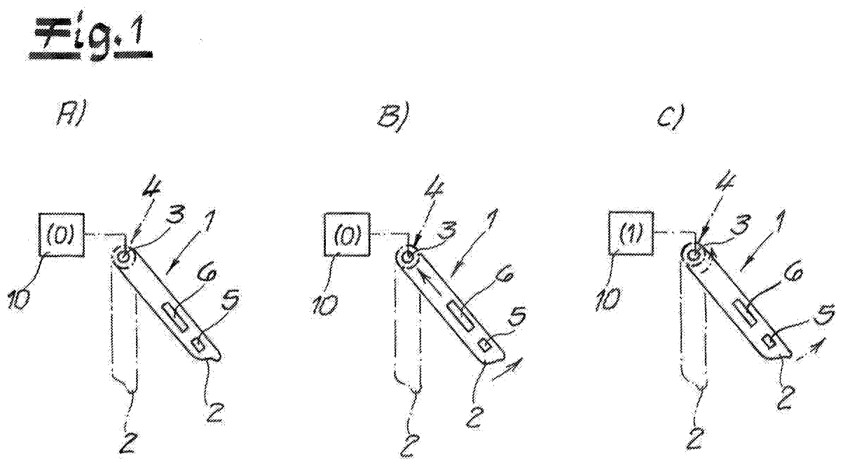

FIG. 1A-1C schematically show the method according to the invention and a motor vehicle door operated according to the method, and

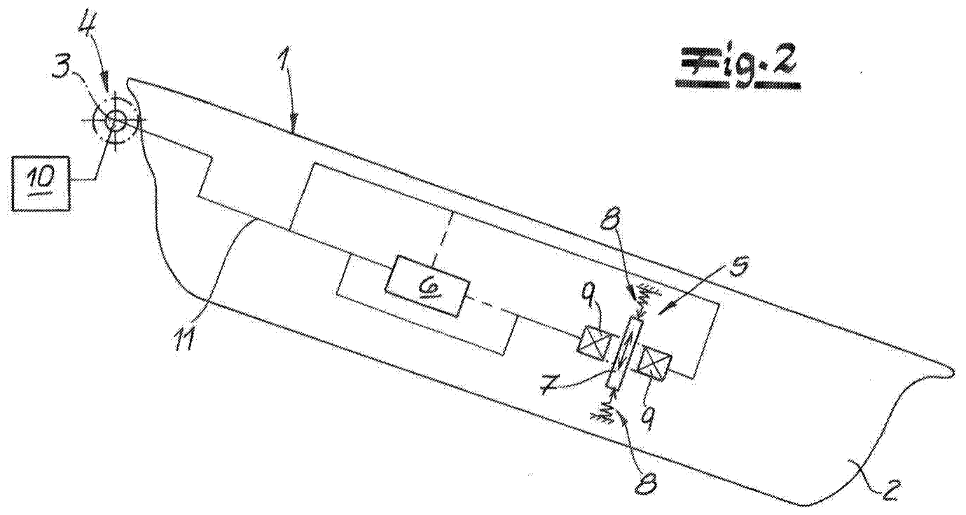

FIG. 2 shows the motor vehicle door and the sensor in detail, and

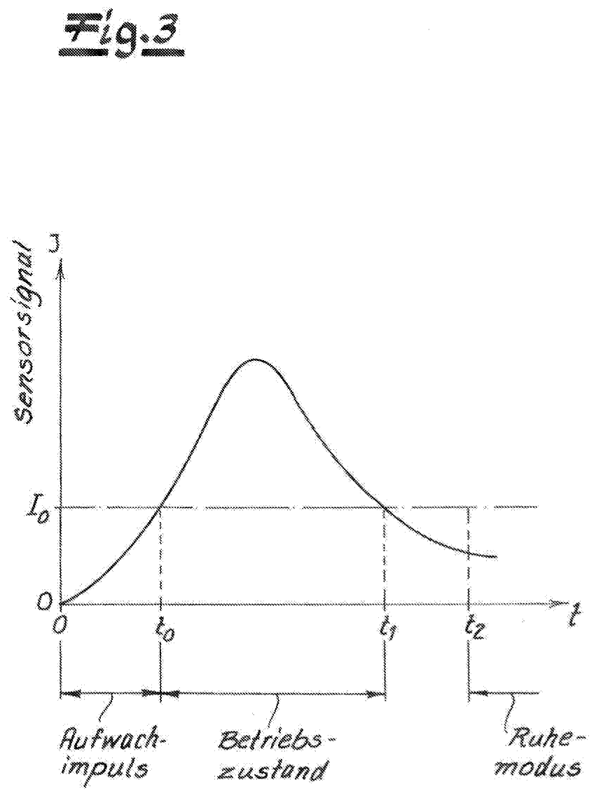

FIG. 3 schematically shows the sensor signal over time.

The figures show a motor vehicle door 1, which can be pivoted, with its door leaf 2, from a closed position indicated by a dot-dashed line into an open position, shown by a solid line, about an axis 3. In the embodiment, the motor vehicle door 1 is a motor vehicle side door, a motor vehicle flap, a fuel filler flap, etc. That is to say that the term motor vehicle door 1 is to be interpreted broadly and ultimately includes all flaps, closures, etc. that are movable relative to a vehicle body. These can also include flaps located in the interior of the motor vehicle body, such as a glovebox flap. The term “motor vehicle door 1” is also understood to mean both rotationally and slidingly or otherwise movable motor vehicle doors, motor vehicle flaps, motor vehicle roofs, etc.

In the context of the invention, it is now proceeded in such a way that the motor vehicle door 1 in question is equipped with an actuator 4. The actuator 4 may act on or in the region of the axis or axis of rotation 3, and ensures that, with its aid, the door leaf 2 can be opened or closed, or a pivoting movement of the door leaf 2, initiated by a user, can be assisted. The actuator 4 is a therefore a current consumer.

The basic structure additionally also includes a sensor 5 in conjunction with a control unit 6. It can be seen that the control unit 6 and the sensor 5 are arranged in the door leaf 2 of the motor vehicle door 1. Of course, this is not imperative and it is only important, within the scope of the invention, that door movements of the motor vehicle door 1 or the door leaf 2 can be detected with the aid of the sensor 5. For this purpose, signals of the sensor can be detected by means of the control unit 6, depending on the registered door movements.

The control unit 6 can now be transferred from a rest mode into an operating mode, and back. In this case, the rest mode of the control unit 6 is characterized in that not only the control unit 6 but also the actuator 4 acted upon by the control unit 6 are deenergized.

The same is true of the sensor 5. In order now to transfer the control unit 6 from the rest mode into the operating mode, and thus to ensure that the actuator 4 is controlled by means of the control unit 6 and can assist the movement of the door leaf 2 as described, the sensor 5, which is also deenergized in the rest mode, now ensures that a current pulse is generated by the door movement.

Using the current pulse, the control unit 5 is woken up and transferred from the rest mode to the operating mode. For this purpose, the invention proceeds, in detail, in such a way that the sensor 5 according to the embodiment is designed as an inductively operating acceleration sensor and has an induction unit 5. According to the embodiment, the sensor 5 and the induction unit 5 are synonymous or coincide. In principle, however, it is also possible for the sensor 5 to contain or comprise the induction unit 5, and additionally to be equipped with a sensor element in the form of a semiconductor sensor, a Hall sensor, etc., in order to be able to detect, with the aid thereof, the door movements of the motor vehicle door 1. However, this is not shown.

The induction unit 5 or the sensor 5 according to the embodiment now operates such that, according to FIG. 2, the induction unit 5 is equipped with a permanent magnet 7 which can be moved back and forth linearly in the direction of the arrow indicated in FIG. 2. This permanent magnet 7 moves relative to two stationary coils 9. In this case, the permanent magnet 7 is not only held in the interior of the coils 9 and guided therein, but rather springs 8 provided on one or both sides ensure that the permanent magnet 7 is not damaged during its linear movement, but rather in each case experiences resilient braking at each end.

The two coils 9 are each connected to the control unit 6. Instead of the linearly operating induction unit 5 shown in FIG. 2, alternatively or additionally a rotationally operating induction unit 5, already explained in the introduction to the description, can also be used.

Either way, a movement of the motor vehicle door 1 or its door leaf 2 about the axis 3 leads, in the example case, to the linear movement of the permanent magnet 7, associated therewith, inducing an electrical current in the coils 9 which, according to the graph in FIG. 3, leads to a growth of the sensor signal or sensor current I proceeding from the deenergized state (0). This corresponds to a wakeup pulse generated by means of the sensor 5. This wakeup pulse or current pulse of the sensor 5 ensures that the control unit 6 is woken up. As a result, the control unit 6 transitions from the deenergized rest mode into the operating mode.

In order to realize and implement this in detail, the current pulse or wakeup pulse in question, generated by the sensor 5 by the movement of the motor vehicle door 1, ensures that a power supply unit 10 assigned to the control unit 6 is activated. In a comparison of FIG. 1A-1C with FIG. 2, it can be seen that the power supply unit 10 is provided on the vehicle body side, whereas the control unit 6 and the sensor 5 are arranged in the door leaf 2 of the motor vehicle door 1. The sensor 5 is now coupled to the power supply unit 10 via a communication link 11. In fact, it can be seen from FIG. 2 that the sensor 5 is electrically continuously connected to the communication link 11, whereas the coupling of the sensor 5 to the control unit 6 can be implemented optionally, which is indicated by a correspondingly dashed connection.

In this way, the current pulse or wakeup pulse generated by means of the sensor during a movement of the door leaf 2 and thus of the motor vehicle door 1 ensures that the power supply unit 10 assigned to the control unit 6 is first activated. The power supply unit 10 activated in this way now in turn transfers the control unit 6 from the rest mode into the operating mode. For this purpose, the power supply unit 10 is coupled to the control unit 6 so that, in the case of an activated power supply unit 10, the control unit 6 transitions directly from its deenergized state, assumed previously and in the rest mode, into the operating state. The same may apply for the sensor 5.

The communication link 11 between the sensor 5 and the power supply unit 10, shown in the figures, can be realized and implemented both by wire and wirelessly or both. In this case, the overall design is such that, in the rest mode, only the communication link 11 is active in order to transmit the current pulse or wakeup pulse generated by the sensor 5 during a movement of the motor vehicle door 1 directly to the power supply unit 10, which is then activated and, in turn, subsequently transfers the control unit 6 from the rest mode into the operating mode. In contrast, in the rest mode, both the sensor 5 and the control unit 6 and power supply unit 10 are deenergized overall.

FIG. 1A-1C show the individual phases during the transition from the rest mode into the operating mode. FIG. 1A shows the rest mode of the motor vehicle door 1 or the door leaf 2. The power supply unit 10 is deactivated, which is associated with the state “0”. This rest mode is assumed as soon as the sensor signal shown in FIG. 3 or the current I output by the sensor 5 is below a threshold value I₀. Instead of the threshold value I₀, however, a threshold band can also be evaluated. At the same time, a period of time is registered when the sensor signal falls below the threshold value I₀. This includes the starting time t₁. If the sensor signal is now permanently below the specified threshold value I₀ over a period of time from t₁ to t₂ in FIG. 3, the control unit 6, the sensor 5, and also the power supply unit 10 pass into the rest mode. This includes the functional state in FIG. 1A.

If, proceeding herefrom, the motor vehicle door 1 or its door leaf 2 is now moved as indicated by FIG. 1B, this initially ensures that the sensor 5 generates the previously mentioned current pulse or wakeup pulse. A current increase starting from the deenergized state, indicated in FIG. 3, corresponds to this. In this case, the wakeup pulse may correspond to a period of time up to the point in time to, in this case the threshold value I₀ of the sensor signal, again already discussed, or another threshold value, may again be exceeded, and the transition from the previously assumed rest mode into the subsequent operating mode corresponds to this.

In any case, this wakeup pulse or current pulse on the part of the sensor 5 ensures that, during the transition from FIG. 1B to FIG. 1C, the power supply unit 10 is transferred from its previously assumed deactivated state (0) into the activated state (1). The power supply unit 10 activated in this way now in turn ensures that the control unit 6 changes or is transferred from the rest mode into the operating mode. This has the consequence that the previously deenergized actuator 4 can then also be actuated with the aid of the control unit 6, such that, as a result, the door leaf 2 is acted upon by the actuator 4. Of course, instead of the actuator 4, any other conceivable current consumer can also be activated in or on the motor vehicle door 1 with the aid of the control unit 6, for example a motor vehicle door lock. However, this is not shown. Subsequently, the control unit 6 can register the movements of the door leaf 2, generated by the actuator 4, with the aid of the sensor 5, and control the actuator 4 accordingly.

### LIST OF REFERENCE SIGNS

Motor vehicle door 1
Door leaf 2
Axis 3
Actuator 4
Sensor, induction unit 5
Control unit 6
Permanent magnet 7
Springs 8
Coils 9
Power supply unit 10
Communication link 11
Sensor signal, sensor current I
State (0)

1. A method for operating a motor vehicle door, wherein the motor vehicle door comprises an actuator and/or a motor vehicle door lock in the form of a current consumer, at least one sensor for detecting door movements, and a control unit for operating one or more components of the motor vehicle door,
the method comprising the control unit evaluating signals from the sensor and based on the signals transferring from a rest mode into an operating mode and back again according to the detected door movements,
wherein the sensor is deenergized in the rest mode and one of the door movements causes the sensor that is deenergized in the rest mode to generate a current pulse.

2. The method according to claim 1, wherein the control unit is deenergized in the rest mode and woken up by the current pulse of the sensor, and as a result of the current pulse the control unit transitions from the rest mode to the operating mode.

3. The method according to claim 1, wherein the current pulse activates a power supply unit assigned to the control unit.

4. The method according to claim 3, wherein the activated power supply unit transfers the control unit from the rest mode to the operating mode.

5. The method according to claim 3, wherein the sensor is coupled to the power supply unit via a communication link.

6. The method according to claim 5, wherein the communication link operates wirelessly.

7. The method according to claim 5, wherein, in the rest mode, only the communication link is active whereas the sensor, the power supply unit and the control unit, as well as the current consumers, are each deenergized.

8. The method according to claim 1, wherein the control unit the and the sensor are arranged in a door leaf of the motor vehicle door.

9. The method according to claim 3, wherein the power supply unit is provided on a vehicle body side.

10. The method according to claim 1, wherein the sensor is an inductively operating acceleration sensor including an induction unit.

12. The method according to claim 1, wherein current consumer, the sensor, and the control unit all are deenergized in the rest mode.

13. The method according to claim 3, wherein current consumer, the sensor, the control unit, and the power supply unit all are deenergized in the rest mode.

14. The method according to claim 5, wherein the communication link operates via a wired connection.

15. The method according to claim 10, wherein the induction unit includes a rod shaped magnet that moves linearly relative to one or more stationary coils.

16. The method according to claim 10, wherein the induction unit includes one or more coils that rotate relative to a stationary magnet.

17. The method according to claim 1, wherein sensor includes a Hall sensor.

18. The method according to claim 5, wherein the communication link is active in the rest mode.
